(19) United States
(12) Patent Application Publication
(10) Pub. No.: US 2024/0012103 A1
(43) Pub. Date: Jan. 11, 2024

(54) RADAR SENSOR AND RF ADAPTER FOR A RADAR SENSOR

(71) Applicant: VEGA Grieshaber KG, Wolfach (DE)

(72) Inventors: Roland BAUR, Koenigsfeld (DE); Tobias BADER, Haslach (DE); Thomas ILG, Haslach (DE)

(73) Assignee: VEGA Grieshaber KG, Wolfach (DE)

(21) Appl. No.: 18/347,250

(22) Filed: Jul. 5, 2023

(30) Foreign Application Priority Data
Jul. 5, 2022 (EP) 22 183 105.0

(51) Int. Cl. G01S 7/03

(52) U.S. Cl. CPC G01S 7/032

(57) ABSTRACT

A radar sensor is provided, including a waveguide configured to guide electromagnetic waves; and an RF adapter including an absorber, the absorber at least partially surrounding the waveguide and being an electrical component configured to absorb electromagnetic waves, and is also a mechanical component of the radar sensor.

### CROSS-REFERENCE TO RELATED APPLICATIONS

This application claims the benefit of priority under 35 U.S.C. § 119 from European Patent Application No. 22 183 105.0 filed on 5 Jul. 2022, the entire content of which is incorporated herein by reference.

### TECHNICAL FIELD

The invention relates to a radar sensor, a use of an absorber as a mechanical component in a radar sensor, and a radio frequency (RF) adapter comprising such an absorber.

### BACKGROUND

In radar sensors, for example for level measurement of liquids and bulk solids for monitoring industrial processes, electromagnetic waves generated by an RF chip are coupled into a waveguide, which is expanded, for example, into a horn radiator to radiate the conducted wave in the waveguide as a spatial wave or serves as an antenna feed. If a galvanic isolation is inserted during the coupling, the waves escape from the waveguide. Here they propagate along e.g., housing parts or other structures and are reflected. The resulting different propagation times cause interference with the waves in the waveguide. To avoid this, absorbers are used. The radar sensor can be designed in such a way that the absorber can be inserted into the radar sensor within the sensor housing. For example, it is glued in place. Provision of the absorber function by the absorber requires a mechanical effort to hold the absorber in its particular position. Grooves for seals must be inserted in such a way that they do not impair the absorbers function.

### SUMMARY

Therefore, one object of the invention could be to provide an improved radar sensor with an absorber.

The task is solved by the objects of the independent patent claims. Advantageous embodiments are the subject of the dependent claims, the following description, and the figures.

The embodiments described similarly relate to the radar sensor, the use of an absorber as a mechanical component in a radar sensor, and the RF adapter. Synergistic effects may result from various combinations of the embodiments, although they may not be described in detail.

In embodiments, a radar sensor is provided that includes an electronics unit having, for example, RF signal generation and conditioning chips on a circuit board. The electronics unit thus generates electromagnetic waves and couples them into a waveguide, which is a feed to an antenna or is part of the antenna, and/or receives electromagnetic waves from the waveguide. For this purpose, the waveguide runs, for example, in its longitudinal axis perpendicular to the board and is formed by several parts that require mechanical support. For this purpose, a structural assembly is used to which the circuit board can be attached and which holds these parts with the waveguide stably in its position or at the desired angle, or supports it, and which provides mechanical protection from external forces as well as protection from the environment. The mechanical assembly also includes a housing, the structural, mechanical assembly contemplated herein being within the housing, and referred to herein as the RF adapter. The RF adapter may include one or more components. An absorber, the actual function of which is to absorb spurious waves, embodied herein is one of these components.

According to a first aspect, there is provided a radar sensor comprising a waveguide for guiding electromagnetic waves, and an RF adapter comprising an absorber, wherein the absorber at least partially surrounds the waveguide and is an electrical component for absorbing electromagnetic waves, as well as being a mechanical component of the radar sensor.

In this context, “electrical component” means that the component is electrically effective by absorbing electromagnetic waves.

By “mechanical component” is meant that the component is a functional mechanical component for the structural, mechanical design of the radar sensor and has other mechanical functions for the sensor.

A structural mechanical assembly has various mechanical functions. These are, for example, to provide mechanical stability to the sensor, to protect parts of the sensor, to hold parts of the sensor together, to position parts, to provide sealing, etc. Mechanical components of this assembly support one or more of these functions. Accordingly, it should not be understood herein that the mechanical component is merely a physical body with no mechanical function, such as a physical body or object that performs or is intended to perform only electrical functions.

Thus, in addition to its electrical functions, namely to absorb electromagnetic waves, in particular interference radiation, the absorber also fulfills essential mechanical tasks such as those mentioned above. The absorber has a sufficiently high density and strength for this purpose.

The radar sensor is for example and not exclusively an industrial sensor for level measurement or point level measurement. Applications include level limit measurement and level measurement of liquids and bulk solids, e.g., for monitoring industrial processes or level measurement in the storage of high-purity water, or level and level limit measurement in the preparation tank of dairy cultures. The waveguide may be, for example, a round waveguide or a rectangular waveguide.

The waveguide may be an antenna feed and/or may expand to form or merge into a horn antenna or horn radiator itself.

According to an embodiment, the radar sensor further comprises an electronics unit having an RF component and an adapter element configured to have the electronics unit attached to a first side thereof and the absorber attached to a second side thereof.

The adapter element is preferably metallic, for example a zinc die-cast element. However, it may also be made of another metal or partly of plastic, as long as it is capable of receiving and transmitting the RF signal generated by the RF chip. The adapter element serves to mechanically fix a circuit board of the electronic unit on a first side, and the absorber on the second side. The circuit board is equipped with electronic components on both sides, for example. In particular, it has an RF chip which may be arranged on that side of the board which is oriented towards the adapter element. The RF chip has an interface to the waveguide as output or input. The waveguide may be formed or arranged with respect to its longitudinal axis perpendicular to the board at this interface. The waveguide is formed at least in part by the adapter element.

According to an embodiment, the RF adapter further comprises an insulating element and a waveguide component, wherein the insulating element is disposed between the adapter element and the waveguide component.

The insulating element is an element for galvanic isolation of the waveguide component, i.e., the waveguide section leading to the antenna aperture, from the board or the adapter element lying at the same potential.

The entire waveguide is formed by a hole or bore in the preferably metallic adapter element, which is electrically connected to the board and in particular the RF chip, and the waveguide component, and the electromagnetic wave is guided in the waveguide through the adapter element and the waveguide component to the antenna. In many applications, galvanic isolation is required between the electronics, i.e., PCB and RF chip, and the antenna.

Depending on the absorber material, this galvanic isolation can be achieved completely or at least partially by the insulating element, which is inserted between the two waveguide parts and thus separates the waveguide into two parts, and which thus represents an intermediate piece between these two parts. This non-metallic intermediate piece creates a path for the electromagnetic waves out of the waveguide, essentially along the surfaces of the adapter element and the waveguide component into the further sensor body. The absorber prevents propagation and associated reflections and spurious radiation. In the case where the absorber is conductive, it may be additionally insulated to prevent bridging of the galvanic isolation. The additional insulation could consist of a layer of varnish or an additional non-conductive bushing, as will be described below. For non-conductive absorbers, this additional insulation is not necessary.

The insulating element is hollow on the inside and thus continues the waveguide so that the electromagnetic waves are carried on from the first waveguide part to the second waveguide part, referred to here as the waveguide component. Thus, for example, on the transmitting side, the wave generated by the RF chip is received by the waveguide part formed by the adapter element and guided via the insulating element to the waveguide component, which guides the wave to the antenna aperture where it is radiated. On the receiving side, the wave is guided in the opposite direction accordingly.

The waveguide component is thus an element separate from the adapter element, forming part of the waveguide at its radial center, for example.

The waveguide component is held in place by the surrounding absorber, as detailed below. The shape may contain narrowed and widened sections that prevent movement in the direction of the central axis, i.e., toward or away from the board.

According to an embodiment, the waveguide component is a component made of metal or a metallized plastic part.

The waveguide component is designed to provide the metallic waveguide. This can be realized by the entire waveguide component being metallic. Alternatively, the waveguide component can also be a plastic part with a metallic section. In particular, the plastic part can be metallized, with only the waveguide bore being metallized. This ensures that the waveguide component is conductive on the inside but insulating on the outside.

For example, the adapter element is shaped like a T in the center, i.e., in the area of the waveguide, as seen in a radial section, and the insulating element is shaped like a U in a complementary manner so that the two parts can be inserted into each other. The waveguide component, seen in a radial section, is also shaped similar to a U-shape and surrounds the insulating element laterally on the outside as well as from the bottom side of the U-shape. Thus, the insulating element is firmly embedded between these parts. However, the shapes can also be formed in other ways.

According to an embodiment of the radar sensor, the absorber surrounds the insulating element and the waveguide component.

By surrounding the insulating element and the waveguide component, the absorber holds the element and the component. “Surrounding” in this context means that the absorber, similar to a cylinder, surrounds the insulating element or the waveguide component in a radial direction and extends over the insulating element and the waveguide component parallel to the longitudinal axis of the waveguide. The insulating element is optional and can be omitted if galvanic isolation is not necessary or not desired.

The adapter element can also be regarded as a connector, which connects the part of the sensor housing the circuit board with the part of the sensor serving to emit the electromagnetic waves, i.e., for example second waveguide part, absorber, insulating element, etc. A part of the connector, i.e., the adapter element, here at least partially embraces the absorber, which on the inside abuts against a metallic part containing the waveguide, which in turn is pressed against a projecting central part of the connector. Thus, both the absorber and the second waveguide part and the insulating element are held in place when they are inserted into the plug designed in this way. Further fixing measures are not excluded here.

With the absorber fixed in place, the sensor, or the internal sensor assembly, thus gains stability. The absorber can fill a significant space between the housing and further parts, such as the waveguide component described in more detail below, which partially surrounds the second waveguide part or in which a part of the waveguide is formed, and can extend without restriction in the direction of the antenna opening. The absorber thus has a supporting function for the mechanical stability of the sensor.

The absorber preferably has a substantially rotationally symmetrical, e.g., annular, structure. That is, it has a rotationally symmetrical basic structure that deviates from it with respect to elements that serve for fastening, or grooves, for example. These elements include, for example, screw holes for receiving screws or elements for mounting the PCB or the RF chip. The grooves are used, for example, to accommodate sealing rings. In the assembled state, the waveguide is preferably located in the center of the substantially rotationally symmetrical absorber.

According to an embodiment, the absorber comprises an insulating sleeve that is at least partially filled with an absorber material.

When the sensor is assembled, the absorber is located between the die-cast zinc adapter element and the waveguide component that contains the second waveguide part. Since the absorber material may have some conductivity to perform its function, this would negate the desired galvanic isolation. Therefore, the absorber material is covered with an insulating material so that the galvanic isolation is ensured. The insulating material, for example plastic, thus forms an insulating sleeve for the absorber material. The insulating sleeve is preferably completely filled with the absorber material, but may also be only partially filled therewith.

According to an embodiment, the absorber has an interface with a housing.

The interface thus represents an outer surface of the absorber that is in direct contact with the housing. This measure also stabilizes the structure. The term “outside” is used herein with respect to a radial direction from a central axis formed by the waveguide toward the housing.

For example, a fit, e.g., an interference fit, can be used here by means of which the absorber is fitted or clamped, or held. For example, the absorber has an oversize for the fit at this point.

Following the adapter element, there is a free space in the direction of the antenna opening, in which the absorber can in principle be designed as desired. For example, it can extend between the waveguide component with the second waveguide part and the housing. The waveguide component thus presses the absorber radially against the housing, giving the arrangement additional stability and centering the second waveguide part.

According to an embodiment, the absorber has a thread on its outer surface for screwing the absorber to the housing of the radar sensor or a fit for fitting the absorber into the housing of the radar sensor.

The thread is another measure that contributes to the mechanical stability of the sensor, holding together and stabilizing the absorber and thus indirectly the components inside the absorber. The absorber can have further threads, which serve, for example, to accommodate screws, so that it can be connected to other parts of the sensor by means of screws, or to connect to the waveguide component already mentioned. The screws and the screw connections are designed here in such a way that no conductive connection is established between the adapter element and the waveguide component.

According to an embodiment, surfaces of the absorber are planar.

In this context, planar means that the surfaces have no surface structure, such as grooves or other patterns, apart from threads, grooves or other structures with a mechanical function.

According to an embodiment, the waveguide component has a circumferential groove for receiving a sealing ring.

The sealing ring, e.g., an O-ring, is arranged to provide a seal between the absorber and the waveguide component. This prevents substances or media, e.g., liquids or vapors, from entering the radar sensor from the direction of the antenna or from the surroundings of the sensor, e.g., through the housing or the cover.

The groove may be provided at this point as an alternative or in addition to another groove in the absorber. A groove for a sealing ring can also be present at further locations of the absorber or the mechanical structure. For example, a groove for a seal may be located between the absorber and the adapter element. The absorber thus supports a sealing function.

The sealing function can also be achieved by an interference fit, a thread or by an adhesive connection.

According to an embodiment, the absorber has a circumferential centering section that is configured to center the adapter element and/or the waveguide component.

The shape of the centering section can be cylindrical. The adapter element can be designed in such a way that it has a projection circumferentially up to the housing in the direction of the antenna or radiation direction. The centering section and the adapter element can be designed in such a way that the inner side of the circumferential, projecting part of the adapter element and the outer side of the further inner, circumferential centering section abut or engage with each other, so that the adapter element and the absorber are positioned or centered relative to each other.

The centering section merges into the further part of the absorber. The absorber including the centering section forms an envelope around the optional insulating element and the waveguide component. Since the absorber surrounds the waveguide component, the entire assembly of absorber, waveguide component, insulating element and waveguide is centered, with the axis of the waveguide forming the central axis of this assembly.

Additionally, centering is provided by a design of the absorber and the metallic part in the lower area of the sensor. The “lower area” is understood here to be the area of the sensor that is close to the antenna aperture. Accordingly, the “upper” region is the region near the electronic unit, which includes the adapter element. The waveguide component can have a widening in the lower region defined in this way, in which the groove for the sealing ring can also be located. Correspondingly, the absorber can have a narrowing or a circumferential recess in this area, so that the absorber and the waveguide component are also complementary in this area and abut each other. This achieves a centering of the waveguide component.

Three different measures can thus be taken for insulation, either on their own or in combination with each other: Plastic adapter element with a metallized waveguide part, absorber with a plastic sleeve and waveguide element with a metallized waveguide. In all of the above measures, an insulating element is also used between the waveguide parts for galvanic isolation.

Thus, an absorber for a radar sensor is also described in the present disclosure. The absorber surrounds a waveguide of the radar sensor and is both an electrical component for absorbing electromagnetic waves and, at the same time, a mechanical component of the structural mechanical assembly of the radar sensor.

According to a further aspect, an RF adapter comprising an absorber for a radar sensor is provided, wherein the absorber is configured to at least partially surround a waveguide of the radar sensor, and wherein the absorber is an electrical component for absorbing electromagnetic waves and is simultaneously a mechanical component of the radar sensor.

The waveguide can be formed, for example, by a hole in the adapter element, and the waveguide component as well as a continuation in the insulating element in between.

According to another aspect, a use of an absorber as a mechanical component in a radar sensor is provided.

“Mechanical component” in this context means that the element or absorber performs mechanical functions as explained above.

Other variations of the disclosed embodiments may be understood and carried out by those skilled in the art in carrying out the claimed invention by studying the drawings, the disclosure, and the appended claims. In the claims, the word “comprising” does not exclude other elements or steps, and the indefinite article “a” or “one” does not exclude a plurality. The mere fact that certain measures are recited in interdependent claims does not mean that a combination of such measures cannot be advantageously used.

### BRIEF DESCRIPTION OF THE FIGURES

In the following, embodiments of the invention are explained in more detail with reference to the schematic drawings. Here shows

FIG. 1 shows a schematic sketch of a radar sensor,

FIG. 2 shows a diagram of a radar sensor in a first sectional view,

FIG. 3 shows a diagram of a radar sensor in a second sectional view,

FIG. 4 shows a diagram of a radar sensor in an alternative embodiment,

FIG. 5 shows a diagram of an absorber in section, and

FIG. 6 shows a diagram of an absorber in a 3D view.

Corresponding parts are marked with the same reference signs in all figures.

### DETAILED DESCRIPTION OF EMBODIMENTS

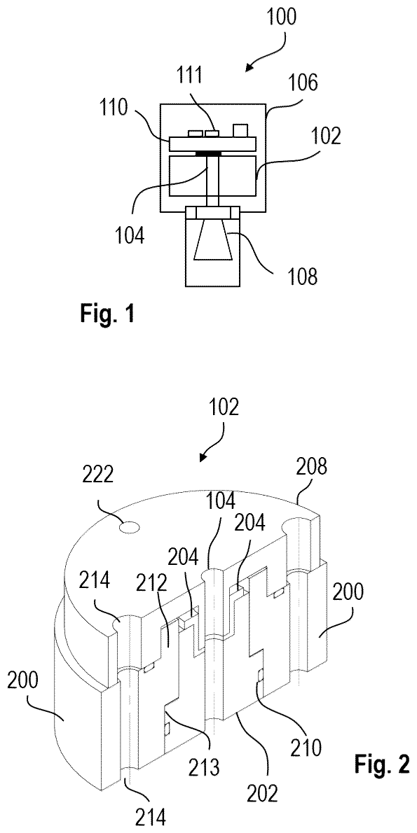

FIG. 1 schematically shows a radar sensor 100 with an RF adapter 102, a waveguide 104, a housing 106, a horn antenna 108, an electronics unit with a circuit board 110, and an RF chip 111. The electronics unit may have several circuit boards and further electronic components as well as interfaces to the outside. Accordingly, several electronic and electromechanical components may be arranged on the circuit board 110, such as processors, active and passive components for signal conditioning, plugs and connectors, etc. The populated circuit board 110 thus forms the electronic unit or at least a part of the electronic unit. The housing 106 is drawn at a distance from the RF adapter 102 in FIG. 1 for the purpose of clearer illustration, but is preferably adjacent to, or connected to, the RF adapter 102. The circuit board 110 is screwed to the RF adapter 102, for example.

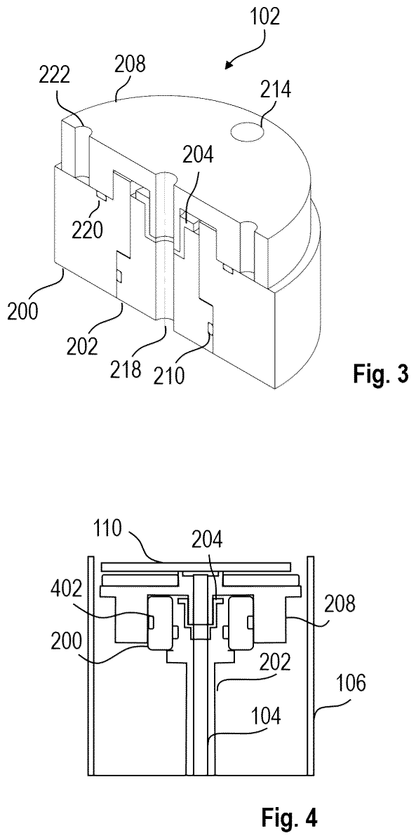

FIGS. 2 and 3 illustrate RF adapter 102 including an absorber 200, a waveguide component 202, an insulating element 204, and an adapter element 208. Reference signs are partially drawn at multiple locations on an element for clarity. The reference signs in the two figures are complementary. These elements or components are surrounded by a housing portion of the housing 106 (not shown in FIGS. 2 and 3). The housing part may be cylindrical and enclose the aforementioned components as well as the components mentioned below. The adapter element 208 may also be referred to as a fastening element or support element according to its mechanical function and is arranged between the circuit board 110 shown in FIG. 1 and other elements such as absorber 200, waveguide component 202 and insulating element 204. The insulating element 204, the adapter element 208, and the waveguide component 202 are configured to form the waveguide 104. The waveguide 104 extends perpendicularly away from the plane of the circuit board 110 and extends parallel to the cylindrical housing wall, such that the waveguide 104 and the housing member have a common central axis 218 that is perpendicular to the plane of the circuit board. It will be understood that there may also be variations from this within the scope of skilled knowledge and practice. For example, the cylindrical or circular shapes described herein may also be oval, rectangular, or otherwise shaped. The housing 106 may include one or more tapers or widenings. Further, the axes of the housing 106 and the waveguide 104 may differ as long as the electrical and mechanical properties are maintained.

Insulating element 204 may be seen as a geometrically central element in FIGS. 2 and 3. The insulating element 204 may have a snap-fit structure on the side that engages a recess of the waveguide component 202, so that the insulating element 204 can be pushed into the waveguide component during assembly and the lug of the snap-fit structure engages the recess so that the insulating element 204 is fixed in the waveguide component 202. The insulating element 204 has an angular U-shaped configuration in the sectional view in FIGS. 2 and 3, or a pot-shaped configuration taking into account the three dimensions, and may also have a stair-shaped configuration with a central stair step, for example. The waveguide component 202 has a suitable complementary structure to accommodate the insulating element 204. In the assembled state, a projecting edge of the U-shape or pot-shape of the insulating element 204 abuts the end edges of the U-shaped structure of the waveguide component 202, so that the insulating element 204 largely abuts the waveguide component 202 on the outside. The adapter element 208 is pin-shaped in the central region, i.e., it has a T-shape in the region of the insulating element 204 in sectional view, whereby the (hollow) pin or the projecting central piece of the T-shaped section of the adapter element 208 fits snugly into the insulating element 204 so that this piece sits centered in the insulating element 204 and the insulating element 204 and the waveguide component 202 are also centered by the aforementioned U-shaped or pot-shaped structures. The insulating element 204 provides a galvanic isolation between the adapter element 208 and the waveguide component 202, i.e., the part of the waveguide that is connected to the RF chip or board and the part of the waveguide that is connected to the antenna.

The waveguide component 208 may have an initial waist-like configuration along the central axis 218 in the direction of the antenna 108, or a straight configuration as shown in FIGS. 2 and 3, followed by a wide section. The waist-like configuration is one of several measures described herein, such as bolting or centering, to ensure a precise fit of the absorber 200 and the waveguide component 202.

The wide portion of the waveguide component 202 has a circumferential groove 210 into which a seal can be inserted. The waveguide 104 runs centrally through the adapter element 208, the insulating element 204 and the waveguide component 202. The absorber 200 surrounds the waveguide component 202 and the insulating element 204. The adapter element 208 has a wide projection away from the board 110 in its outer region, i.e., in the section that adjoins the T-shaped section in the radial direction, so that the T-shape is extended to an E-shape—as seen in the sectional plane—of an E lying relative to the T. The projection corresponds to the upper and lower lines of the horizontal E and is circular in plan view. The projection here is wide enough to include holes 214, 222 or bores 214, 222 that can receive a screw. The holes 214, 222 may extend through the entire thickness of the adapter element 208 in this case. A portion of the holes 214 or screw holes 214 may extend into the absorber 200, so that the adapter element 208 may be connected to the absorber 200 by means of a screw connection. For this purpose, the adapter element 208 may include a recess in the protrusion so that the circuit board 110 covers the heads of the screws. Thus, the absorber 200 includes a hole 214 or screw hole 214 that can receive the screw. Further holes 222 or screw holes 222 connect the PCB 110 to the RF adapter 102, allowing the RF chip 111 to be screwed tightly to the adapter element during assembly and the chip 111 to be connected to the waveguide in an RF-tight manner, and the adapter element 208 to be assembled in an independent step with the absorber including the waveguide component 202 and the insulating element 204. Alternatively, the electronic unit can be directly screwed to the adapter element and the absorber.

The absorber further comprises a centering section 212, which cylindrically extends the absorber toward the circuit board 110 and has its end portion abutting the base side and its outer side abutting the inner side of the projection of the adapter element 208, so that the adapter element 208 and the absorber 200 are positioned, or centered, with respect to each other.

The centering section 212 merges into the further part of the absorber 200. The absorber 200 including the centering section 212 surrounds the insulating element 204 and the waveguide component 202. The section 213 also has the function of a centering section. For this purpose, the inner side of the centering section 213 lies against the outer side of the waveguide component 202.

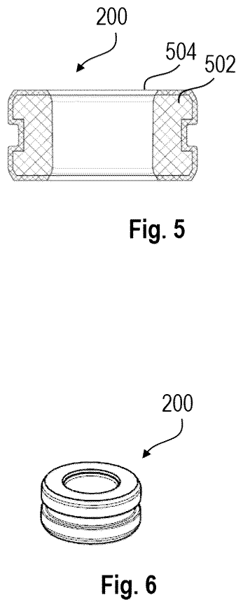

FIG. 4 shows a diagram of a portion of a sensor 100 having an absorber 200 according to another embodiment, wherein the absorber includes an insulating sleeve 502. Such an absorber is sketched in FIGS. 5 and 6. In this embodiment example, the absorber 200 is annular and comprises an insulating layer 504 made of plastic. The insulation layer 504 forms a sleeve 502 containing an absorbent filler, for example carbon fiber. For example, the insulating layer 504 is made of a thermoplastic material, such as PVDF (polyvinylidene fluoride). Further, the absorber 200 includes a groove 506 for a gasket 402.

Thus, a radar sensor 100 having a waveguide 104 for guiding electromagnetic waves and an RF adapter 102 having an absorber 200 is provided, wherein the absorber 200 at least partially surrounds the waveguide 104 and is an electrical component 202 for absorbing electromagnetic waves, and at the same time is a mechanical component 202 of the radar sensor 100, that is, a component having the electrical and mechanical functions mentioned and described herein. Furthermore, in embodiments, an insulating function is presented in particular of the absorber 200, but also of the waveguide component 202 and the adapter element 108.

### LIST OF REFERENCE SIGNS

100 Radar sensor
102 RF adapter
104 Waveguide
106 Housing
108 Horn antenna
110 Board
111 RF chip
200 Absorber
202 Waveguide component
204 Insulating element
208 Adapter element
210 Groove for gasket
212 Absorber section for centering
213 further absorber section for centering
214 Screw hole/hole for screw
218 central axis
220 Groove for gasket
222 Screw hole/hole for screw
402 Seal
502 Plastic sleeve
504 Absorbent material filling, insulating layer
506 Nut, groove

1. A radar sensor, comprising
a waveguide configured to guide electromagnetic waves; and
an RF adapter comprising an absorber,
wherein the absorber at least partially surrounds the waveguide and is an electrical component configured to absorb electromagnetic waves, and is also a mechanical component of the radar sensor.

2. The radar sensor according to claim 1, further comprising an electronics unit comprising a circuit board and an RF component, and an adapter element configured to have the electronics unit attached to a first side thereof and the absorber attached to a second side thereof.

3. The radar sensor according to claim 2,
wherein the RF adapter further comprises an insulating element and a waveguide component, and
wherein the insulating element is disposed between the adapter element and the waveguide component.

4. The radar sensor according to claim 3, wherein the absorber at least partially surrounds the insulating element and the waveguide component.

5. The radar sensor according to claim 3, wherein the waveguide component is a component made of metal or a metallized plastic part.

6. The radar sensor according to claim 1, wherein the absorber comprises an insulating sleeve at least partially filled with an absorber material.

7. The radar sensor according to claim 1, wherein the absorber has an interface with a housing.

8. The radar sensor according to claim 7, wherein the absorber has a thread on an outer side thereof for screwing the absorber to the housing of the radar sensor or a fit for fitting the absorber with the housing of the radar sensor.

9. The radar sensor according to claim 1, wherein surfaces of the absorber are planar.

10. The radar sensor according to claim 1, wherein the waveguide component includes a circumferential groove configured to receive a sealing ring.

11. The radar sensor according to claim 1, wherein the absorber comprises a circumferential groove configured to receive a sealing ring.

12. The radar sensor according to claim 1, wherein the absorber comprises a circumferential centering section configured to center the adapter element and/or the waveguide component.

13. An RF adapter for a radar sensor, comprising an absorber configured to at least partially surround a waveguide of the radar sensor, wherein the absorber is an electrical component configured to absorb electromagnetic waves and is also a mechanical component of the radar sensor.
